(19) United States
(12) Patent Application Publication
(10) Pub. No.: US 2012/0040599 A1
(43) Pub. Date: Feb. 16, 2012

(54) SANDWICH BOARD FOR AN INNER WALL CLADDING OF A PASSENGER CABIN

(75) Inventors: Florian HESSELBACH, Blaustein (DE); Dietmar VÖLKLE, Biberach (DE)

(73) Assignee: DIEHL AIRCABIN GMBH

(21) Appl. No.: 13/207,953

(22) Filed: Aug. 11, 2011

(30) Foreign Application Priority Data
Aug. 11, 2010 (DE) 10 2010 034 028.6

(51) Int. Cl. B60H 1/26; B32B 3/10; B32B 3/24; B32B 3/26

(52) U.S. Cl. 454/143; 428/195.1; 428/138; 428/99

(57) ABSTRACT

To implement replenished-air ventilation of a passenger cabin of, for example, an aircraft, an inner wall cladding (12) with integrated replenished-air inlets (18) is proposed. For this purpose, the inner wall cladding (12) has sandwich boards (30) which are constructed from a first top layer (32) facing the passenger cabin (10), a second top layer (34) facing away from the passenger cabin (10) and a sandwich core (36) arranged between the first top layer (32) and the second top layer (34), the sandwich core (36) being designed to be at least partially air-permeable, and the first top layer (32) having at least one air-permeable portion (38).

### BACKGROUND OF THE INVENTION

The present invention relates to a sandwich board for an inner wall cladding, particularly of a passenger cabin of a vehicle, to an inner wall cladding with at least one such sandwich board and to a passenger cabin of a vehicle having an inner wall cladding with at least one such sandwich board.

The invention is in this case applicable especially preferably to a passenger cabin of aircraft, but may also be used advantageously in other vehicles, such as long-distances coaches, rail vehicles and watercraft.

### DISCUSSION OF THE PRIOR ART

Conventional ventilation systems of vehicles, such as aircraft, are based on the principle of mixed ventilation. In this case, fresh air is blown into the passenger cabin via air outlets, and the spent air in the passenger cabin is sucked away via air outlets which consist, for example, of half-shells glued to one another in a composite fibre type of construction. In aircraft, pressure equalization in the passenger cabin can also be regulated via this ventilation system.

It is customary, further, that the passenger cabins are provided, for improving the comfort of passengers, with an inner wall cladding which is attached to the inside of a carrying structure (designated as the fuselage in aircraft). Such inner wall claddings often consist of sandwich structures with two top layers and with a single-layer or multi-layer sandwich core between them. In addition to having an aesthetic appearance, such inner wall claddings should also be easy to clean during the care of the interior of the passenger cabin and should have high mechanical strength. The inner wall cladding may be mounted with a clearance in relation to the carrying structure, in order to fill the interspace thus occurring with insulating elements.

### SUMMARY OF THE INVENTION

The object on which the invention is based is to provide an improved ventilation system for a passenger cabin of a vehicle.

This object is achieved by means of a sandwich board having the features of claim 1, an inner wall cladding having the features of claim 6 and a passenger cabin having the features of claim 8. Advantageous refinements and developments of the invention are the subject matter of the dependent claims.

The sandwich board for an inner wall cladding, in particular of a passenger cabin of a vehicle, according to the invention has a first top layer facing the passenger cabin, a second top layer facing away from the passenger cabin and a sandwich core arranged between the first top layer and the second top layer, the sandwich core being designed to be at least partially air-permeable, and the first top layer having at least one air-permeable portion.

The sandwich board for the inner wall cladding is constructed from two top layers and one single-layer or multi-layer sandwich core, in order to satisfy all requirements as to an inner wall cladding, that is to say, in particular, so as to have sufficient mechanical stability and rigidity and provide an attractive cabin design which can be cleaned as easily as possible.

A replenished-air ventilation system or part of a replenished-air ventilation system is integrated in a compact way into this sandwich board. In particular, the sandwich core is designed to be at least partially air-permeable in order to form an air duct, and the first top layer, facing the passenger cabin, of the sandwich board has at least one air-permeable portion which serves as a replenished-air outlet.

In contrast to the conventional mixed-air concepts for passenger cabins, the replenished-air concept set up with a sandwich board designed in this way for the inner wall cladding provides cabin ventilation with high air quality, low airflow velocities and stable airflow conditions in the passenger cabin.

By the replenished-air concept being integrated into the inner wall cladding of the passenger cabin, moreover, advantages in terms of weight, of assembly and of cost can be achieved. In particular, this integration avoids the need for additional air lines.

“Replenished-air ventilation” is to be understood in this context as meaning the introduction of a low-impetus airflow in to the passenger cabin. The airflows within the passenger cabin are then determined by the heat sources and heat sinks. The introduction of the replenished air takes place, for example, near the floor and it is sucked away in the region of the ceiling of the passenger cabin. The air velocities occurring in the passenger cabin are extremely low, and therefore there are generally no signs of any appreciable draughts.

The “top layers” and the “sandwich core” of the sandwich board may in each case be of single-layer or multi-layer design, depending on requirements. Moreover, basically any desired materials and combinations of materials may be processed for the sandwich board. Furthermore, the sandwich board is not restricted to specific shapes and sizes; in particular, the sandwich board does not have to be designed as a planar board, but may even be curved, in order to adapt to the vehicle structure. Furthermore, the two top layers of the sandwich board may selectively run essentially parallel to one another or be at a variable distance from one another. Also, the thicknesses (measured in the direction of connection) of the first top layer, the second top layer, the sandwich core and the entire sandwich board will be selected either to be constant or to be variable throughout the sandwich board.

The “sandwich core” of the sandwich board designates in most general terms the structure between the two top layers. It may, for example, be formed from knobbed, folded, slotted or perforated honeycombs, woven structures, foams or other structures. Moreover, the sandwich core, depending on its set-up, may have the function of acoustic insulation and/or thermal insulation.

The “air permeability” of the sandwich core and of the air-permeable portion of the first top layer is selected such as to afford air permeability which is sufficient for replenished-air ventilation and is as uniform as possible. The air permeability of the sandwich core may simply arise from the same structure, for example from the same porosity. Should the air permeability of the sandwich core not be sufficient or when the air permeability is to be influenced in a directed way, it is possible to introduce ducts for air guidance into the sandwich core. With an appropriate configuration of the ducts, it is possible, for example, to set the ventilation properties or to influence them advantageously. The ducts may be introduced into the sandwich core or into its core material essentially by means of any desired methods, particularly methods such as milling or the action of laser radiation and the like being considered.

In one refinement of the invention, the at least one air-permeable portion of the first top layer is designed to be at least partially porous or perforated.

In a further refinement of the invention, the at least one air-permeable portion of the first top layer is provided at least partially with an air-permeable membrane.

The air-permeable portion of the first top layer of the sandwich board according to the invention may, for example, be designed to be porous, be provided with an air-permeable membrane or designed to be porous and provided with an air-permeable membrane.

The sandwich board is in this case preferably also designed such that if required (that is to say, for example, in the event of a sudden pressure drop in the passenger cabin of an aircraft) pressure compensation can be brought about in the passenger cabin (what is known as the “rapid decompression” function).

In one refinement of the invention, the second top layer of the sandwich board is designed to be essentially air-impermeable, and the sandwich core is connectable to an air source or the sandwich core has a connecting device for connection to an air source. The air is thus supplied to the sandwich board via the sandwich core.

In another refinement of the invention, the second top layer has at least one air-permeable portion. The air can thus be supplied, for example, via the interspace between the sandwich board and a carrying structure of the vehicle.

An inner wall cladding, in particular for a passenger cabin of a vehicle, may be equipped with at least one sandwich board of this type. Preferably, not all the sandwich boards of the inner wall cladding are designed according to the present invention.

In one refinement of the invention, the at least one sandwich board of the invention is integrated releasably into the inner wall cladding. The replenished-air ventilation of a passenger cabin can thereby be maintained in a simple way, and defective sandwich boards can simply be exchanged.

The inner wall cladding designed according to the invention can be connected to at least one air source for generating a low-impetus replenished-airflow.

In one refinement of the invention, the inner wall cladding has a side wall cladding with at least one sandwich board according to the invention in the near-floor region.

In a further refinement of the invention, the inner wall cladding has a bottom with at least one sandwich board according to the invention.

### BRIEF DESCRIPTION OF THE DRAWINGS

The above and further features and advantages of the invention become more easily understandable from the following description of preferred and non-restrictive exemplary embodiments, with reference to the accompanying drawings in which:

FIG. 1 shows a diagrammatic cross-sectional view of a passenger cabin of an aircraft according to a first exemplary embodiment;

FIG. 2 shows a diagrammatic cross-sectional view of a passenger cabin of an aircraft according to a second exemplary embodiment;

FIG. 3 shows a diagrammatic cross-sectional view of a passenger cabin of an aircraft according to a third exemplary embodiment;

FIG. 4 shows a diagrammatic partial cross-sectional view of an inner wall cladding of a passenger cabin according to a first preferred embodiment;

FIG. 5 shows a diagrammatic partial cross-sectional view of an inner wall cladding of a passenger cabin according to a second preferred embodiment.

### DETAILED DESCRIPTION OF THE INVENTION

The invention is explained in more detail below by the example of a passenger cabin of an aircraft. However, the concept according to the invention is applicable likewise to passenger cabins of other vehicles, such as long-distance coaches, rail vehicles and watercraft.

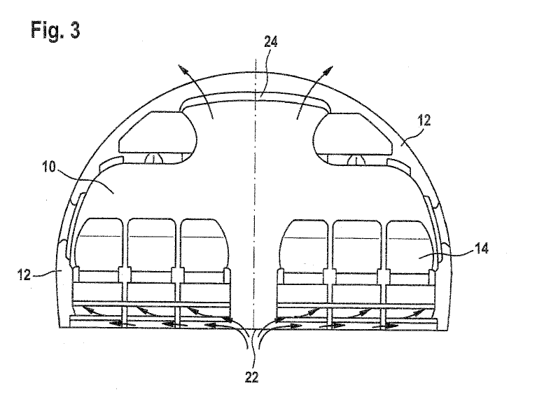

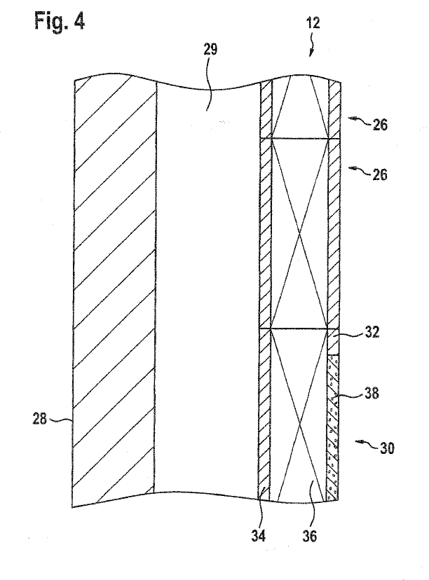

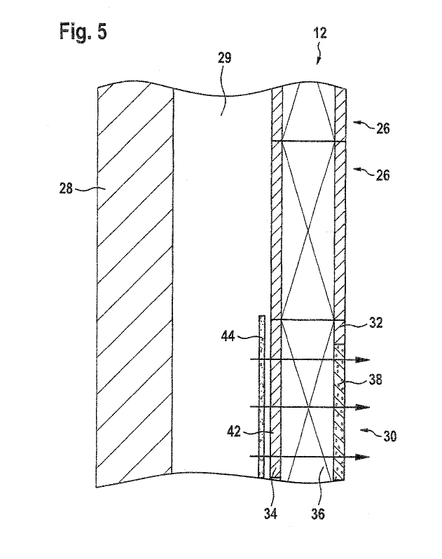

First, with reference to FIGS. 1 to 3, various concepts of replenished-air ventilation of the passenger cabin are presented by way of example, in which the inner wall cladding according to the invention can advantageously be used. Then, with reference to FIGS. 4 and 5, two different embodiments of an inner wall cladding according to the invention for implementing the replenished-air ventilation concept are described.

The passenger cabin 10 of the aircraft is provided with an inner wall cladding 12 which is provided, on the one hand, on the side walls and the ceiling and, on the other hand, also on the floor or intermediate floor. This inner wall cladding serves for the comfort of passengers and affords a visually attractive design.

Stowage compartment rows 16 are also provided above the seat rows 14 in the inner wall cladding in the overhead region for the passengers. Moreover, what are known as PSUs (Passenger Service Units, Passenger Seat Units), are mounted in the region of these stowage compartment rows 16.

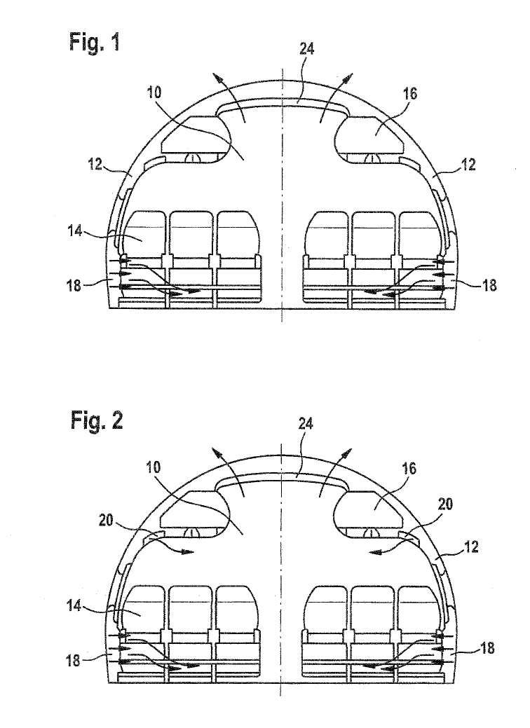

To implement the replenished-air ventilation concept, various replenished-air inlets may be integrated in the inner wall cladding 12. As illustrated in FIGS. 1 to 3, replenished-air inlets 18 may be introduced in the sidewall cladding in the near-floor region (FIGS. 1 and 2), replenished-air inlets 20 may be introduced in the sidewall cladding underneath the stowage compartment rows 16 (FIG. 2) and/or replenished-air inlets 22 may be introduced in the floor of the passenger cabin.

The low-impetus replenished-airflow from these replenished-air inlets 18-22 gives rise in the passenger cabin 10 to only low airflow velocities. The airflows are caused in the passenger cabin 10 essentially only by the existing heat sources and heat sinks. The air rising in the passenger cabin 10 is finally sucked away from the passenger cabin 10 via a replenished-air outlet 24 in the ceiling region.

Referring to FIG. 4, then, a first embodiment of an inner wall cladding 12 with an integrated replenished-air outlet is explained in more detail.

The inner wall cladding 12 of the passenger cabin 10 is composed of a plurality of sandwich boards 26 which are attached to a carrying structure (aircraft fuselage) 28 of the aircraft. Preferably, between the aircraft fuselage 28 and the inner wall cladding 12, an interspace 29 is provided, into which insulating material (in particular, thermal and acoustic) is inserted.

In addition to the conventional sandwich boards 26, the inner wall cladding 12 also has a plurality of sandwich boards 30 configured according to the invention for providing the replenished-air outlets 20-22.

As illustrated in FIG. 4, these special sandwich boards 30, like the other sandwich boards 26 of the inner wall cladding 12, are constructed from a first top layer 32 facing the passenger cabin 10, a second top layer 34 facing away from the passenger cabin 10, that is to say facing the aircraft fuselage 28, and a sandwich core 36 between these two top layers 32, 34. The sandwich core 36 is designed to be at least partially air-permeable and contains, for example, knobbed, folded, slotted or perforated honeycombs, a porous foam, a spacer fabric or a built-up core.

While the second top layer 34 is designed to be essentially air-impermeable, the first top layer has at least one air-permeable portion 38. When the sandwich core 36 of this sandwich board 30 is connected to a corresponding air source, the air flows through a sandwich core 36 and emerges from the air-permeable portion 38 of the first top layer 32 with low impetus into the passenger cabin 10. Preferably, the sandwich core may have a connection for connecting to an air source or may be connected to an air source via the air-permeable sandwich cores 36 of adjacent sandwich boards 30.

The air-permeable portion 38 of the first top layer 32 of the sandwich board 30, the said portion serving as a replenished-air outlet, is designed, for example, to be porous or perforated (for example, by means of the laser perforation of a fibre-reinforced plastic layer). Alternatively or additionally, an air-permeable membrane may also be provided for this air-permeable portion 38.

Referring to FIG. 5, then, a second embodiment of an inner wall cladding with an integrated replenished-air outlet is explained in more detail. In this case, the same components are again identified by the same reference numerals as in the first embodiment of FIG. 4

Whereas, in the first embodiment, the sandwich core 36 of a sandwich board 30 serves as a air guide duct between the air source and the replenished-air outlet, the replenished air is supplied to the air-permeable portion 38 of the first top layer 32 from the interspace 29 between the aircraft fuselage 28 and the inner wall cladding 12. For this purpose, the second top layer 34 also has at least one air-permeable portion 42, so that the air can emerge through the air-permeable portion 42 of the second top layer 34, the air-permeable sandwich core 36 and the air-permeable portion 38 of the first top layer 32 into the passenger cabin 10,

Like the air-permeable portion 38 of the first top layer 32, the air-permeable portion 42 of the second top layer 34 may be designed to be porous or perforated and/or may be provided with an air-permeable membrane. Furthermore, a filter device 44 is preferably attached to the air-permeable portion 42 of the second top layer 34, in order to purify and/or dry the air from the interspace 29.

In both embodiments of FIGS. 4 and 5, the replenished-air ventilation is integrated into the inner wall cladding 12 of the passenger cabin 10. The special sandwich boards 30 of the inner wall cladding 12 are in this case, like the other sandwich boards 26 of the inner wall cladding 12, configured such that they afford an attractive design, can be cleaned easily and are of stable construction. Furthermore, the special sandwich boards 30 are installed preferably releasably in the inner wall cladding 12, so that they can simply be removed and exchanged, for example, for maintenance and repair purposes.

What is claimed is:

1. A sandwich board for an inner wall cladding, in particular of a passenger cabin of a vehicle, with
a first top layer facing the passenger cabin;
a second top layer facing away from the passenger cabin; and
a sandwich core arranged between the first top layer and the second top layer, wherein
the sandwich core is designed to be at least partially air-permeable; and
the first top layer has at least one air-permeable portion.

2. The sandwich board according to claim 1, wherein
the at least one air-permeable portion of the first top layer is designed to be at least partially porous or perforated.

3. The sandwich board according to claim 1, wherein
the at least one air-permeable portion of the first top layer is provided at least partially with an air-permeable membrane.

4. The sandwich board according to claim 1, wherein
the second top layer is designed to be essentially air-impermeable and the sandwich core is connectable to an air source.

5. The sandwich board according to claim 1, wherein
the second top layer has at least one air-permeable portion.

6. An inner wall cladding, in particular for a passenger cabin of a vehicle, comprising at least one sandwich board according to claim 1.

7. The inner wall cladding according to claim 6, wherein
the at least one sandwich board is integrated releasably into the inner wall cladding.

8. A passenger cabin of a vehicle, with an inner wall cladding comprising at least one sandwich board according to claim 1 and with at least one air source, connected to the inner wall cladding, for generating a low-impetus replenished-airflow.

9. The passenger cabin according to claim 8, wherein the inner wall cladding has a sidewall cladding with at least one sandwich board in the near-floor region.

10. The passenger cabin according to claim 8, wherein the inner wall cladding has a bottom with at least one sandwich board.
